(19) United States
(12) Patent Application Publication
(10) Pub. No.: US 2009/0209727 A1
(43) Pub. Date: Aug. 20, 2009

(54) Process for the production of a material that is degradable in a natural environment with a renewable carbon base

(75) Inventors: Jacques Barbier, Montamise (FR); Frederic Bataille, Sevres-Anxaumont (FR); Cedric Dever, Chasseneuil Du Poitou (FR)

Correspondence Address: YOUNG & THOMPSON, 209 Madison Street, Suite 500, ALEXANDRIA, VA, 22314, US

(73) Assignee: CENTRE VALORISATION INDUSTRIEL AGRORESSOURCES, ASSOCIATION LOI 1901, POITIERS (FR)

(21) Appl. No.: 12/071,320

(22) Filed: Feb. 20, 2008

(51) Int. Cl. C08G 63/00

(52) U.S. Cl. 528/361

(57) ABSTRACT

A process for the production of a polyhydroxycarboxylic acid that is loaded with plant meals, includes the following stages:
Polycondensation of a hydroxycarboxylic acid for forming a functionalized prepolymer,
Reaction of the prepolymer that is functionalized with an extension agent in the presence of plant meals for forming a polyhydroxycarboxylic acid of highly loaded mass. The polyhydroxycarboxylic acid that is obtained and its use as a biodegradable material are also disclosed.

This invention relates to a process for the production of a polyhydroxycarboxylic acid that is loaded with plant meals.

The invention also covers the product that is obtained and its use as a biodegradable material in a natural environment.

It is known that controlled-biodegradability materials are increasingly sought after, in particular the materials that can break down in a natural environment without requiring that microorganisms be specifically supplied.

Currently, the biodegradable materials in a natural environment are generally obtained from non-renewable raw materials of petrochemical origin. They are not ecological and are rarely entirely degraded.

Also, there is therefore a need for materials based on renewable material, entirely degradable of course, i.e., by invoking essentially chemical and photochemical mechanisms.

This is the purpose of this invention in proposing a process for obtaining a polyhydroxycarboxylic acid that is loaded with plant meals.

The production process according to the invention comprises the implementation of the following stages:
Polycondensation of a hydroxycarboxylic acid for forming a functionalized prepolymer, and
Reaction of the prepolymer that is functionalized with an extension agent in the presence of plant meals for forming a polyhydroxycarboxylic acid of highly loaded mass.

The polyhydroxycarboxylic acid that is obtained by the implementation of the process according to the invention can be used as a biodegradable material.

This polyhydroxycarboxylic acid is entirely degradable in a natural environment.

Advantageously, this acid, based on renewable carbon, is not harmful to the environment.

Other characteristics and advantages will emerge from the description in detail of the following production process according to the invention, according to a nonlimiting embodiment that is illustrated by two particular examples.

### I. Process for Producing Polyhydroxycarboxylic Acid According to the Invention

I. 1. Stage 1: Polycondensation of a Hydroxycarboxylic Acid

The first stage of the process consists in polycondensing a hydroxycarboxylic acid by direct dehydration in the presence of a diol or diacid compound for forming a functionalized prepolymer.

The reaction that occurs is as follows:

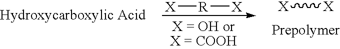

Preferably, lactic acid or glycolic acid is used as a hydroxycarboxylic acid.

The polycondensation is carried out under vacuum at high temperature:
The pressure is between 1 and 900 mbar, more particularly between 20 and 600 mbar,
The temperature is between 100 and 200° C., more particularly between 140 and 200° C.

Preferably, the polycondensation is carried out in the presence of catalysts, which make it possible to increase the speed of the reaction.

Among the catalysts that are able to be used for this invention, it is possible to cite the metals of groups I, II, III and IV of the periodic table, or salts based on these metals. In particular, it is possible to cite tin octoate, sulfuric acid, titanium butoxide, titanium isopropoxide, tin oxide, antimony oxide, dibutyltin dilaurate and zirconium acetylacetonate.

Preferably, succinic acid or adipic acid, such as diacid or 1,4-butanediol, is used as diol.

This first stage makes it possible to obtain an acid or hydroxyl functionalized prepolymer with a low molar mass on the order of 1,000 to 5,000 g/mol.

### I. 2. Stage 2: Formation of a Polyhydroxycarboxylic Acid

The second stage of the process consists in reacting the functionalized prepolymer with an extension agent in the presence of plant meals for forming a polyhydroxycarboxylic acid of highly loaded mass.

The extension agent reacts on the acid or hydroxyl functions of the prepolymer.

The reaction that occurs is as follows:

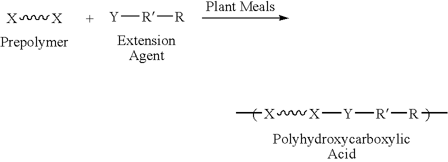

Preferably, a compound that is selected from among:
The oxazolines, in particular the bis-oxazolines,
The caprolactams, in particular the bis-caprolactams, and
The isocyanates, in particular the di-isocyanates is used as an extension agent.

Among the extension agents that are able to be used for this invention, it is possible to cite, for example, 2,2′-bis(2-oxazoline), 1,3-phenylene-bis(2-oxazoline), carbonylbiscaprolactam or 1,4-butanediisocyanate.

The plant meals can be selected from among:
The amylased cereal meals, such as wheat, corn or rye grains,
The protein grains, such as horse bean, lupine, rapeseed, sunflower, soy or casein grains,
The lignocellulose fibers, such as wood, hemp or flax fibers.

### II. Characterization of the Polyhydroxycarboxylic Acids That are Obtained According to the Invention

The polyhydroxycarboxylic acids that are obtained according to this invention have the following characteristics:
A mean molar mass between 1,000 and 120,000 g/mol in figures,
Polydispersion indices between 1.2 and 2.5, and
Acid indices between 0 and 30 mgKOH/g.

These polyhydroxycarboxylic acids that are obtained according to this invention are totally amorphous polymers with glass transition temperatures of between 35 and 50° C.

They are loaded with plant meals at a height of 1 to 50% of the total mass.

These acids can be used as material that is entirely biodegradable in a natural environment.

### III. EXAMPLES

### Process for Obtaining a Polylactic Acid that is Loaded with Plant Meals

For the following two examples:
The molar masses have been determined at ambient temperature by steric exclusion chromatography,
The acid indices, defined by the weight of potash necessary for the neutralization of 1 g of polymer, have been determined by assay based on the DIN 53402 standard, and
The thermal properties of the materials have been obtained by differential scanning calorimetry.

### III. 1. Example 1

### a—Stage 1: Polycondensation of a Lactic Acid

A flask that contains a mixture of L-lactic acid, succinic acid (between 1 and 5 mol % with regard to the lactic acid) and tin octoate (between 0.1 and 2% by mass of the total mass) is heated between 160 and 190° C., and it is connected to a rotary evaporator.

The assembly is placed under reduced pressure so as to eliminate the water that is produced by the condensation reactions.

At t=0, the mixture is placed at 800 mbar, then the pressure is reduced over time up to about 20 mbar, along a suitable pressure profile as a function of time.

The reaction is stopped after 24 hours, and:
Water,
Lactide in the form of white crystals distributed on the installation walls, and
A prepolymer
   are recovered.

The prepolymer that is obtained has the following characteristics:
It is amorphous with a glass transition temperature of 45° C., and

It has an acid index of 38 mgKOH/g.

### b—Stage 2: Formation of a Polylactic Acid

The prepolymer that is obtained in stage 1 is introduced in a glass pin that is brought to a temperature of between 150 and 190° C. by means of an oil bath.

After one minute, the prepolymer is melted, and an extension agent, 1,3-phenylene-bis-(2-oxazoline), is added. The mixture is homogenized by mechanical stirring.

The polylactic acid that is obtained is recovered between 3 and 7 minutes after total melting of the extension agent.

The polylactic acid that is obtained has an acid index of 3.5 mgKOH/g.

### III. 2. Example 2

### a—Stage 1: Polycondensation of a Lactic Acid

A flask that contains a mixture of L-lactic acid, succinic acid (between 1 and 5 mol % with regard to the lactic acid) and tin octoate (between 0.1 and 2% by mass of the total mass) is heated between 160 and 190° C., and it is connected to a rotary evaporator.

The assembly is placed under reduced pressure so as to eliminate the water that is produced by the condensation reactions.

At t=0, the mixture is brought to 800 mbar.

At t=1 hour, the vacuum dropped to 60 mbar.

At t=8 hours, the temperature is raised to 200° C. for about 90 minutes.

The reaction is stopped after 9 hours and 30 minutes of reaction, and:
Water,
Lactide in the form of white crystals distributed on the assembly walls, and
A prepolymer
   are recovered.

The prepolymer that is obtained has the following characteristics:
It is amorphous with a glass transition temperature of 31° C.,
It has an acid index of 64 mgKOH/g,
It has a polydispersion index of 1.7, and
It has a mean molar mass of 2,290 g/mol in figures.

### b—Stage 2: Formation of a Polylactic Acid

The extension reactions are carried out in an extruder between 160 and 180° C., at a flow rate of between 1.55 and 1.7 kg/h and a torque speed of between 50 and 55 rpm.

The following are mixed in the extruder:
The prepolymer that is obtained in stage 1,
The 1,3-phenylene-bis-(2-oxazoline), and
The wheat meal.

The polylactic acid that is obtained is recovered between 2 and 5 minutes after the introduction of the different elements in the extruder.

The polylactic acid that is obtained has an acid index of 3.1 mgKOH/g. It has two populations of chains:
One with a mean molar mass of 2,340 g/mol in figures and a polydispersion index of 2.4, and
The other with a mean molar mass of 84,470 g/mol in figures and a polydispersion index of 1.3.

If this polylactic acid is left in the water in a specimen, after 53 days the content of the specimen loses 64.1% of its mass, which shows the biodegradable nature of the loaded polylactic acid that is obtained according to the invention.

1. Process for the production of a polyhydroxycarboxylic acid that is loaded with plant meals, characterized in that it comprises the following stages:
Polycondensation of a hydroxycarboxylic acid for forming a functionalized prepolymer,
Reaction of the prepolymer that is functionalized with an extension agent in the presence of plant meals for forming a polyhydroxycarboxylic acid of highly loaded mass.

2. Process for the production of a polyhydroxycarboxylic acid according to claim 1, wherein the polycondensation is carried out by direct dehydration in the presence of a diol or diacid compound.

3. Process for the production of a polyhydroxycarboxylic acid according to claim 1, wherein the polycondensation is carried out by direct dehydration in the presence of succinic acid or adipic acid or 1,4-butanediol.

4. Process for the production of a polyhydroxycarboxylic acid according to claim 1, wherein the polycondensation is carried out in the presence of catalysts.

5. Process for the production of a polyhydroxycarboxylic acid according to claim 4, wherein the catalysts are metals of group(s) I, II, III and/or IV or salts based on these metals.

6. Process for the production of a polyhydroxycarboxylic acid according to claim 1, wherein the extension agent is a compound that belongs to the family of oxazolines, caprolactams or isocyanates.

7. Process for the production of a polyhydroxycarboxylic acid according to claim 1, wherein the extension agent is 2,2′-bis(2-oxazoline), 1,3-phenylene-bis(2-oxazoline), carbonylbiscaprolactam or 1,4-butanediisocyanate.

8. Process for the production of a polyhydroxycarboxylic acid according to claim 1, wherein the plant meals are amylased cereal meals, protein meals or lignocellulose fibers.

9. Polyhydroxycarboxylic acid that is loaded with plant meals and that is obtained from the process according to claim 1 designed to be used as material that is entirely biodegradable in a natural environment, wherein it has the following characteristics:
A mean molar mass between 1,000 and 120,000 g/mol in figures,
Polydispersion indices between 1.2 and 2.5, and
Acid indices between 0 and 30 mgKOH/g.
A glass transition temperature of between 35 and 50° C.,
A plant meal content of between 1 and 50% of the total mass.

10. (canceled)

11. Process for the production of a polyhydroxycarboxylic acid according to claim 2, wherein the polycondensation is carried out by direct dehydration in the presence of succinic acid or adipic acid or 1,4-butanediol.

12. Process for the production of a polyhydroxycarboxylic acid according to claim 2, wherein the polycondensation is carried out in the presence of catalysts.

13. Process for the production of a polyhydroxycarboxylic acid according to claim 2, wherein the extension agent is a compound that belongs to the family of oxazolines, caprolactams or isocyanates.

14. Process for the production of a polyhydroxycarboxylic acid according to claim 2, wherein the extension agent is 2,2′-bis(2-oxazoline), 1,3-phenylene-bis(2-oxazoline), carbonylbiscaprolactam or 1,4-butanediisocyanate.

15. Process for the production of a polyhydroxycarboxylic acid according to claim 2, wherein the plant meals are amylased cereal meals, protein meals or lignocellulose fibers.
